(19) United States
(12) Patent Application Publication
(10) Pub. No.: US 2013/0056324 A1
(43) Pub. Date: Mar. 7, 2013

(54) COUPLING WITH SAFETY LOCK OF THE DRIVESHAFT OF A HAND-TOOL

(71) Applicant: Robert Freund, Paderborn (DE)

(72) Inventor: Robert Freund, Paderborn (DE)

(73) Assignee: FREUND MASCHINENFABRIK GMBH & CO. KG, PADERBORN (DE)

(21) Appl. No.: 13/696,695

(22) PCT Filed: Nov. 5, 2010
(86) PCT No.: PCT/DE2010/075121

§ 371 Date: Nov. 7, 2012

(30) Foreign Application Priority Data
May 7, 2010 (DE) 20 2010 005 399.4

(51) Int. Cl. F16D 11/10

(52) U.S. Cl. 192/69

(57) ABSTRACT

A coupling has a safety lock and receives a flexible driveshaft with a tube into a hand-tool. The coupling contains a pinion as part of a drive transmission of the hand-tool and a lever on a handle. An opening of the pinion can be connected to an end of the driveshaft, and the lever engages into a retaining groove of the tube as long as the lever is gripped together with the handle. In a drive position, a direct positive engagement between the driveshaft and the pinion is produced, and the transmission is thus driven. The coupling contains a spring that pushes the driveshaft into a rearward rest position as soon as the lever on the handle is released, whereby the positive engagement between the driveshaft and the pinion is disengaged and the transmission is thus set to rest.

The invention relates to a coupling with a safety lock for the receiving a flexible driveshaft with a tube into a hand-tool, comprising a pinion, as part of a drive transmission of the hand-tool and a lever on a handle, wherein an opening of the pinion can be connected to an end of the driveshaft, and the lever engages into a retaining groove of the tube, as long as the lever is gripped together with the handle.

In the present-day meat industry, trimmers are used as universal cutting tools for butchering and cutting. Applications for trimmers range from clean removal of the spinal cord and carcass fat throughout recovery of meat from the bone and controlled fat trimming for cattle and pigs up to chicken thigh deboning or cutting poultry backs or breasts or very thin slicing of fish.

From the patent U.S. Pat. No. 4,894,915, such a rotary knife is known which comprises a ring-like housing on a hand piece, in which a rotary ring blade is supported and guided. Here, the ring blade is driven by a pinion which is driven by a flexible driveshaft. A removable body in the hand piece is movable manually within the hand piece in such a way that a spring yieldably biases the body to a position where the pinion is not driven and a hand-engageable member retains the body in a position where the pinion is driven against the force of the spring. The disadvantage here is the complicated design with many parts that are prone to wear and thus cause maintenance costs.

It is the object of the invention to provide a simplified, low-maintenance coupling for hand-tool, which is driven by a flexible driveshaft, which provides for a reduction of wearing parts and is safe to use.

This object is met by the features of claim 1.

Embodiments of the invention are described in the subclaims.

The invention is based on a hand-tool, which is driven by a flexible driveshaft with a tube and which allows to replace the driven working end.

The hand-tool is a trimmer, at the handle of which an annular blade housing is located, inside which a rotary circular blade with circumferential gear teeth is supported. A pinion, which is supported in the handle, engages with the gear teeth, functioning like a driving gear. For agile operation, the trimmer is connected to a motor by means of a flexible driveshaft in a tube, wherein one end of the driveshaft engages in an opening of the pinion. The output shaft of the motor is coupled with the driveshaft for torque transmission. Depending on the application, the trimmer ring blades have different diameters. The design according to the invention allows using the same drive unit with trimmer heads of different sizes, which increases the flexibility of the trimmer. The different size trimmer heads can be changed quickly and easily, without modification, which reduces purchase and maintenance costs.

The handle of the trimmer is fitted with a lever, which is simultaneously gripped when the trimmer is operated. The lever engages in a retaining groove of the tube while the lever is held, and in a driving position, a positive connection between the driveshaft and the pinion is established and the hand-tool is driven. Advantageously, the end of the driveshaft is designed as a polygonal shaft journal having a chamfered tip and the opening of the pinion is also polygonal and chamfered, so that they can interlock with low friction during insertion and extraction. The device further comprises a spring inside the handle, which presses the tube into a rearward rest position as soon as the lever is released by the handle. Thereby the positive engagement between the driveshaft and the pinion is disengaged and the transmission is set to rest, while the driveshaft continues to turn. This results in particularly safe automatic shutdown of the hand-tool when it is not in use, and in particular enables an emergency shutdown of the hand-tool for accident prevention.

In order to reach the drive position, the restoring force of the spring is overcome by manually pushing the tube further into the hand-tool, so that the insertion of the shaft journal into the opening of the pinion is made possible by compressing the spring. This two-handed start of the hand-tool increases safety for the user. Advantageously, the lever engages around the retaining groove of the tube via a clamping piece. The clamping piece is supported in the handle by a spring, so that the force of which is adjustable by means of a threaded pin. The restoring force of this spring again disengages the connection between the clamping piece and the retaining groove when the lever is released. In this embodiment, the rest position is achieved by a retaining ring, which is supported on the inner wall of the handle, so that the tube abuts at it and does not slip out of the hand-tool. The retention can be overcome by a small amount of force and the driveshaft with tube can be pulled manually from the handle.

In another embodiment, a coupling with a control pin is provided between the driveshaft and the pinion, enabling a one-handed start of the hand-tool. The control pin has at one end a polygonal and chamfered opening for the shaft journal, and, at the opposite end, a polygonal and chamfered coupling journal for the opening of the pinion. Thus, a positive connection with the driveshaft on one end and with the pinion on the other side can be established, with easy insertion and extraction. In addition, the control pin comprises on its shaft, in a limited region, a shaft groove, which merges into a ring groove where it terminates. As soon as the lever of the handle is pressed, in a first position a wedge engages in the shaft groove of the control pin, and as long as the lever is held, in a second position, the wedge permanently engages in the ring groove of the control pin. During this process, the control pin is continuously rotated by the driveshaft, so that as a result the control pin is pushed forward and simultaneously, for the driving position, the coupling journal is positively inserted into the opening of the pinion, and the spring is compressed. This enables a faster and more ergonomical start of the hand-tool with one hand. An additional lock on the lever guarantees higher safety for of the user against accidental operation of the hand-tool. In this embodiment, the rest position is achieved by a ball pin in the handle joint, which engages in the retaining groove of the driveshaft through the rotation of an exterior rotating ring on the handle. A rotation in the opposite direction releases the connection between the ball pin and the retaining groove and the driveshaft tube can be removed from the handle without force.

The invention is illustrated by way of example with reference to the figures.

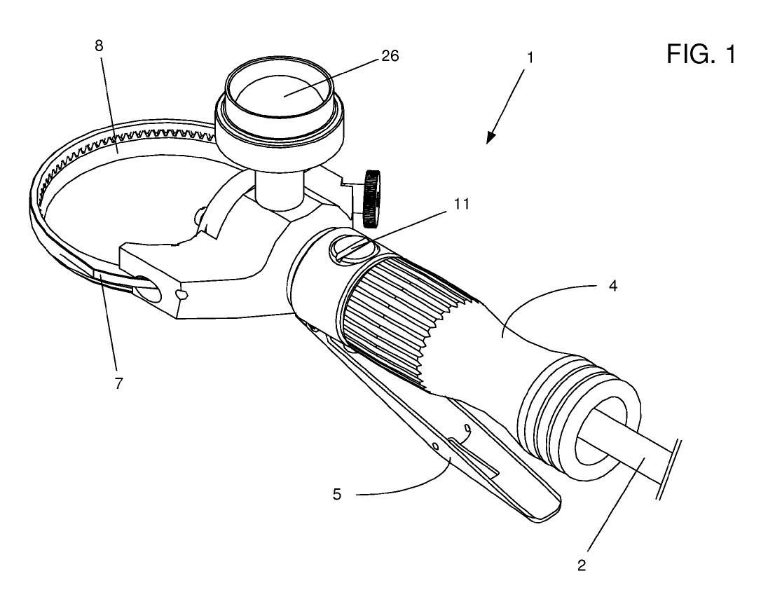

A first embodiment of the invention is explained with reference to the FIGS. 1 to 4.

FIG. 1 shows the trimmer for a two-handed start in isometric view.

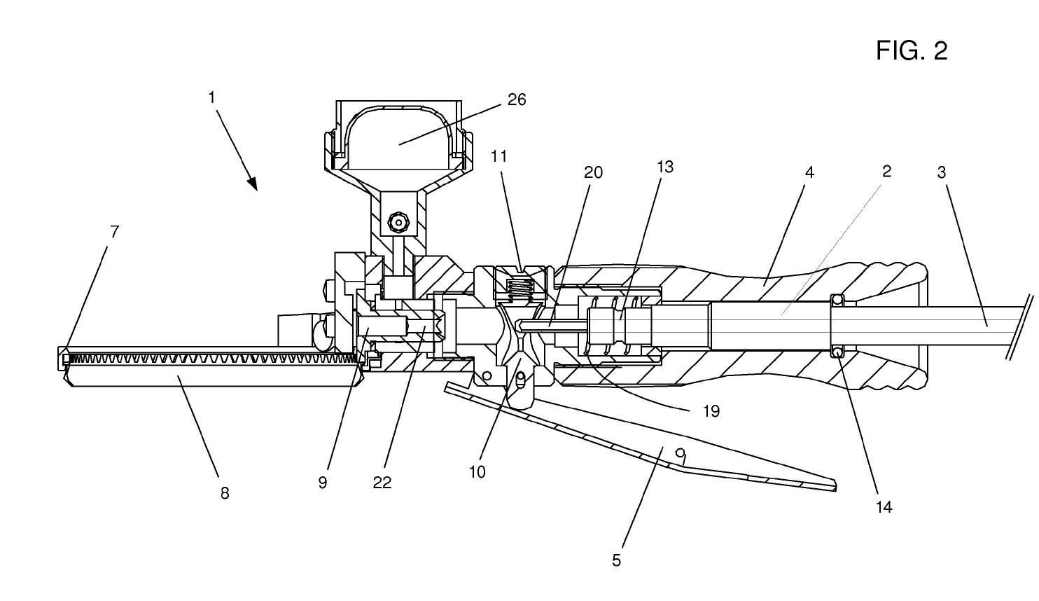

FIG. 2 shows a longitudinal section of the coupling in the rest position.

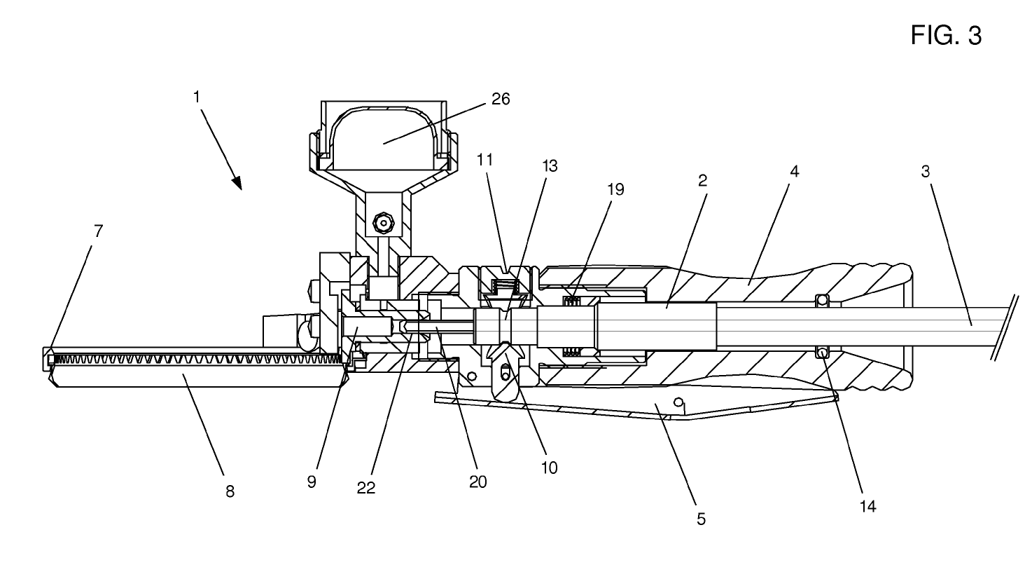

FIG. 3 shows a longitudinal section of the coupling in the drive position

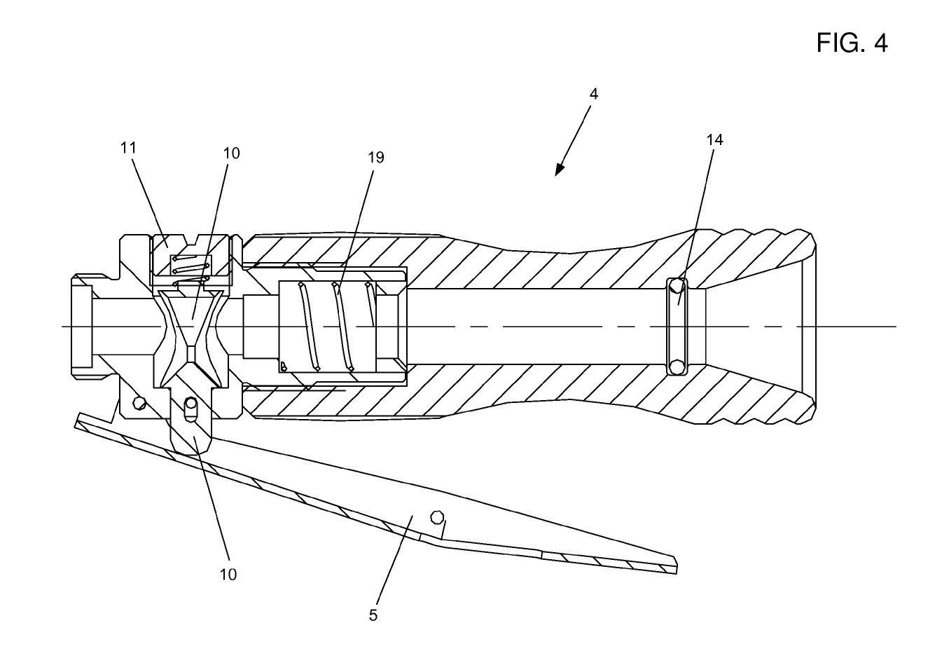

FIG. 4 shows a side view of the handle with the clamping piece and without the driveshaft.

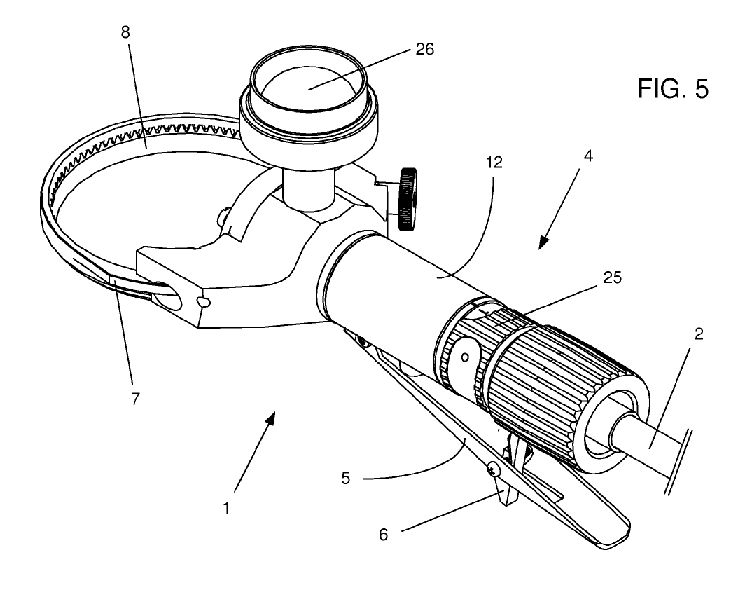

A second embodiment of the invention is explained with reference to the FIGS. 5 to 8.

FIG. 5 shows the trimmer for a one-handed start in isometric view.

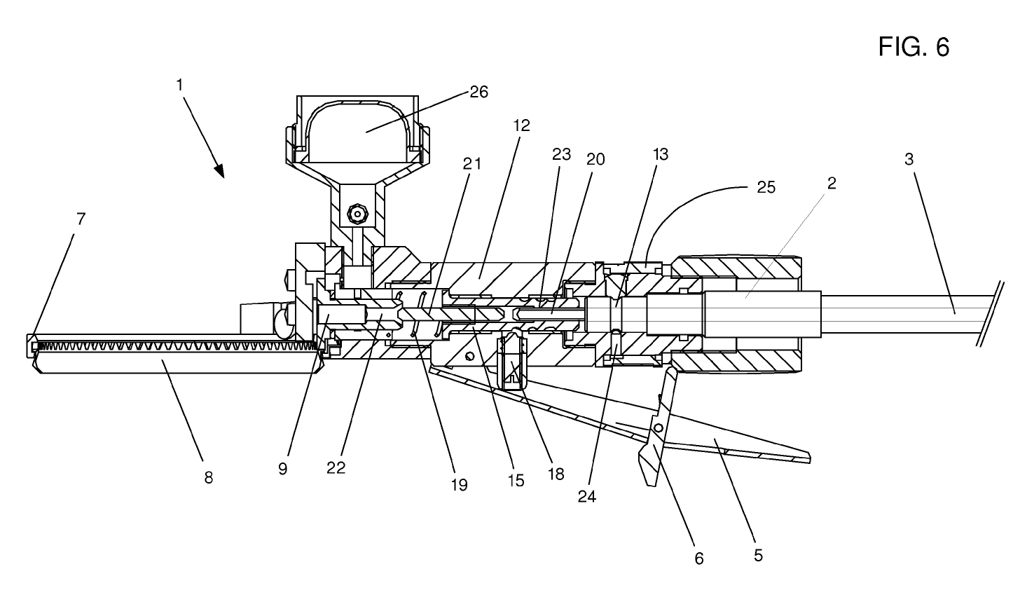

FIG. 6 shows a longitudinal section of the coupling in the rest position.

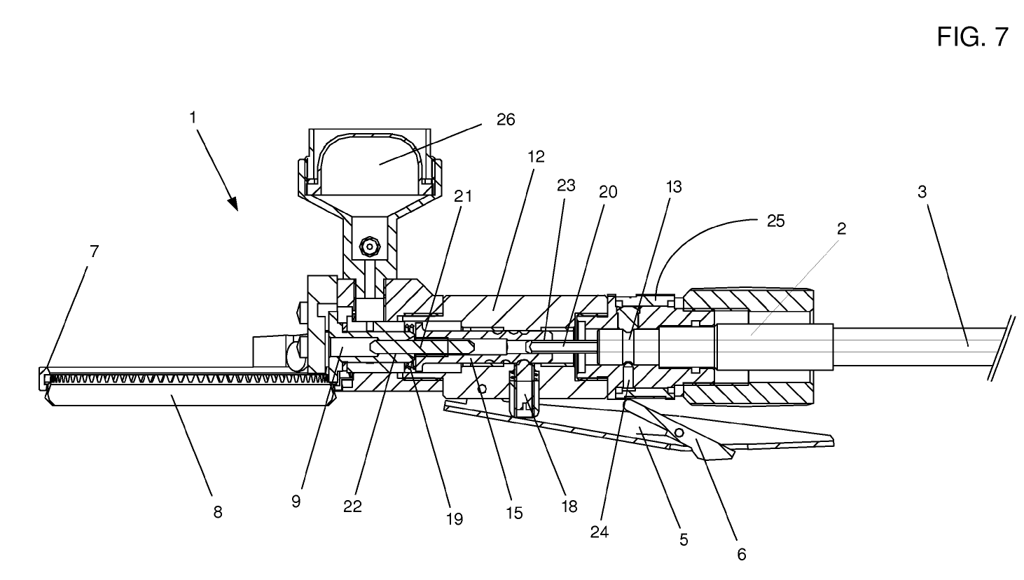

FIG. 7 shows a longitudinal section of the coupling in the drive position

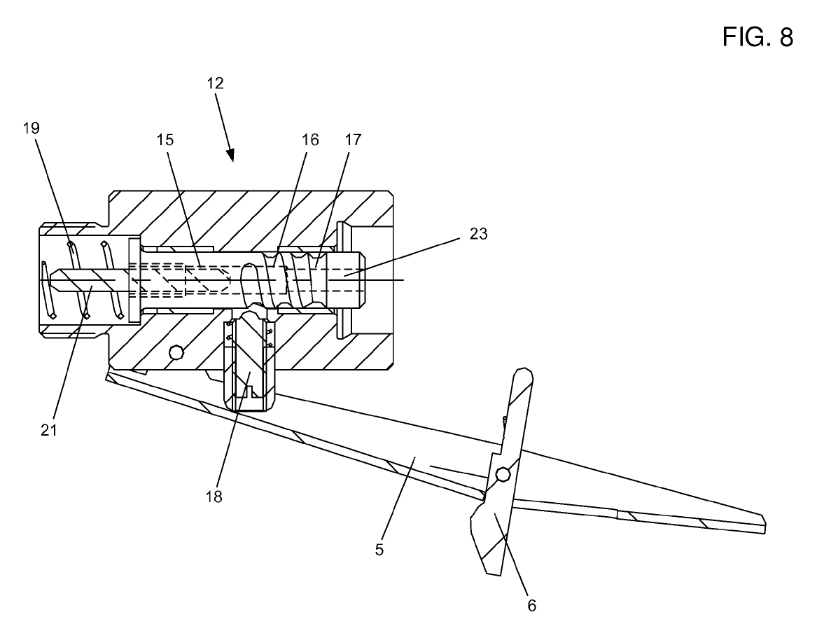

FIG. 8 shows a side view of the coupling with the control pin and without the driveshaft.

The trimmer 1 comprises a handle 4 at the front end of which the annular blade housing 7, containing the rotating ring blade 8, is mounted. The flexible driveshaft with tube 2 is inserted into the opposite end of the handle 4, connecting the trimmer 1 with a drive unit. The lubrication of the trimmer 1 is provided by a grease reservoir 26. A lever 5 is supported on the handle 4, which is gripped together with the handle 4 during the operation of the trimmer 1. A pinion 9 in the handle 4 engages in the ring blade 8, transferring the driving force.

In the first embodiment, starting the trimmer is done by a two-handed double movement at the handle 4, by inserting the driveshaft 3 with tube 2 into the handle, thereby compressing a spring 19 in the handle. As long as the lever 5 is gripped, a clamping piece 10 engages in the retaining groove 13 of the tube 2, and it is made a positive connection is established between the shaft journal 20 of the driveshaft 3 and the opening 22 of the pinion, so that the ring blade 8 is driven, as shown in FIG. 3. Here, the clamping piece 10 is supported, via a spring in the handle 4, in such a manner that the clamping force is adjustable from the outside by a threaded pin 11. This spring disengages the connection between the clamping piece 10 and the retaining groove 13 as soon as the lever 5 is released. Thereby, the driveshaft 3 with tube 2 is pushed into the rearward rest position by the restoring force of the spring 19, which is achieved by the retaining ring 14 in the handle, as shown in FIG. 2.

In the second embodiment, a coupling 12 is arranged between the driveshaft 3 and the pinion 9, which comprises a control pin 15 with a coupling journal 21 for the opening 22 of the pinion at its left end, and an opening 23 for the shaft journal 20 of the driveshaft 3 at its right end. This control pin 15 has, at its shaft, a shaft groove 16, which merges with a ring groove 17, as shown in FIG. 8. When the lever 5 is operated, the wedge 18 engages in the shaft groove 16 of the control pin 15 as shown in FIG. 6, and when the lever 5 is continuously held, the wedge 18 engages the annular groove 17 of the control pin 15. The rotation of the control pin 15 by means of the driveshaft 3 pushes the control pin forward against the force of the spring 19, so that a positive connection is established between the coupling journal 21 and the opening 22 of the pinion, driving the ring blade 8, as shown in FIG. 7. Here, the lever is secured by a lock 6, so that the lever 5 is secured against unintentional operation and thus against an accidental start of the trimmer 1. When the lever 5 is released, the driveshaft 3 with tube 2 is pushed, by the restoring force of the spring 19, to the rearward rest position which is established by a ball pin 24 at the handle, which engages in the retaining groove 13 of the tube 2 through the actuation of an external rotating ring 25 at the handle.

### REFERENCE SIGNS

1 hand-tool, trimmer
2 tube of the driveshaft 3
3 flexible driveshaft
4 handle
5 lever
6 lever lock
7 blade housing
8 ring blade
9 pinion
10 clamping piece
11 threaded pin
12 coupling
13 retaining groove
14 locking ring
15 control pin
16 shaft groove
17 ring groove
18 wedge
19 spring
20 shaft journal
21 coupling journal
22 opening of the pinion
23 opening of the control pin
24 ball pin
25 rotary ring on the handle
26 grease reservoir

1-8. (canceled)

9. A coupling with a safety lock for receiving a flexible driveshaft with a tube into a hand-tool, the coupling comprising:
a pinion being part of a drive transmission of the hand-tool and having an opening formed therein, said pinion can be connected to an end of the flexible driveshaft via the end extending in said opening of said pinion;
a lever disposed on a handle of the hand-tool, said lever engaging into a retaining groove of the tube, as long as said lever is gripped together with the handle;
in a drive position, a direct positive engagement between the flexible driveshaft and said pinion being produced, and the drive transmission is thus driven; and
a spring pushing the flexible driveshaft into a rearward rest position as soon as said lever on the handle is released, whereby the direct positive engagement between the flexible driveshaft and said pinion is disengaged and the drive transmission is thus set to rest.

10. The coupling according to claim 9, wherein the hand-tool is a trimmer, at the handle of the hand-tool an annular blade housing is disposed, inside the annular blade housing a circular blade with circumferential gear teeth is supported in a rotatable manner, said pinion engaging with the gear teeth for driving.

11. The coupling according to claim 9, wherein the end of the flexible driveshaft is a polygonal shaft journal having a chamfered tip.

12. The coupling according to claim 11, wherein said polygonal shaft journal is inserted in a positive engagement into said opening of said pinion, and said pinion being polygonal and chamfered.

13. The coupling according to claim 9, wherein for the drive position, a restoring force of said spring is overcome by manually pushing the tube further into the handle.

14. The coupling according to claim 9, further comprising:
a threaded pin;
a further spring; and
a clamping piece, said lever engaging in the retaining groove of the tube via said clamping piece, said clamping piece supported in the handle by said further spring, a force of said further spring being adjusted by said threaded pin.

15. The coupling according to claim 9, further comprising a locking device, said lever secured by said locking device against an accidental actuation of said lever and thus against actuating the hand-tool.

16. The coupling according to claim 9, wherein the flexible driveshaft is driven by a motor.

17. A hand-tool for receiving a flexible driveshaft having a tube with a retaining groove formed therein and an end, the hand-tool comprising:
a drive transmission having a pinion with an opening formed therein, said pinion connected to the end of the flexible driveshaft via the end extending in said opening of said pinion;
a handle;
a lever disposed on said handle, said lever engaging into the retaining groove of the tube, as long as said lever is gripped together with said handle;
in a drive position, a direct positive engagement between the flexible driveshaft and said pinion being produced, and said drive transmission is thus driven; and
a spring pushing the flexible driveshaft into a rearward rest position as soon as said lever on said handle is released, whereby the direct positive engagement between the flexible driveshaft and said pinion is disengaged and said drive transmission is thus set to rest.

18. The hand-tool according to claim 17, wherein the hand-tool is a trimmer, and further comprising:
an annular blade housing extending from said handle; and
a circular blade disposed inside and rotatably supported by said annular blade housing, said circular blade having circumferential gear teeth, said pinion engaging with said circumferential gear teeth for driving.

19. The hand-tool according to claim 17, wherein the end of the flexible driveshaft is a polygonal shaft journal having a chamfered tip.

20. The hand-tool according to claim 19, wherein the polygonal shaft journal is inserted in a positive engagement into said opening of said pinion, and said pinion being polygonal and chamfered.

21. The hand-tool according to claim 17, wherein for the drive position, a restoring force of said spring is overcome by manually pushing the tube further into said handle.

22. The hand-tool according to claim 17, further comprising:
a further spring;
a threaded pin; and
a clamping piece, said lever engaging in the retaining groove of the tube via said clamping piece, said clamping piece supported in said handle by said further spring, a force of said further spring being adjusted by means of said threaded pin.

23. The hand-tool according to claim 17, further comprising a locking device, said lever secured by said locking device against an accidental actuation of said lever and thus against actuating the hand-tool.

24. A hand-tool, comprising:
a flexible driveshaft having a tube with a retaining groove formed therein and an end;
a drive transmission having a pinion with an opening formed therein, said pinion connected to said end of said flexible driveshaft via said end extending in said opening of said pinion;
a handle;
a lever disposed on said handle, said lever engaging into said retaining groove of said tube, as long as said lever is gripped together with said handle;
in a drive position, a direct positive engagement between said flexible driveshaft and said pinion being produced, and said drive transmission is thus driven;
a spring pushing said flexible driveshaft into a rearward rest position as soon as said lever on said handle is released, whereby the direct positive engagement between said flexible driveshaft and said pinion is disengaged and said drive transmission is thus set to rest; and
a motor for driving said flexible driveshaft.
